(19) United States
(12) Patent Application Publication
(10) Pub. No.: US 2005/0044330 A1
(43) Pub. Date: Feb. 24, 2005

(54) System, apparatus and method for controlling a storage device

(76) Inventors: Gidon Elazar, Tsur-Yigal (IL); Dan Harkabi, Moshav Lachish (IL); Nehemiah Weingarten, Tel-Aviv (IL)

Correspondence Address: SLATER & MATSIL, L.L.P., 17950 PRESTON RD, SUITE 1000, DALLAS, TX, 75252-5793, US

(21) Appl. No.: 10/899,260

(22) Filed: Jul. 26, 2004

Related U.S. Application Data
(60) Provisional application No. 60/490,439, filed on Jul. 28, 2003.

(51) Int. Cl. G06F 12/00

(52) U.S. Cl. 711/154

(57) ABSTRACT

Various embodiments include a system, apparatus and method for a computing device to communicate with a storage device through read/write operations. In some embodiments described, the computing device may be a personal computer. In some embodiments, the storage device may be a removable storage device. In some embodiments the computing device may communicate to the storage device using an interface that is operable with the USB standard. In some embodiments the computing device does not have administrative permissions. Other embodiments are described.

This application claims the benefit of U.S. Provisional Application No. 60/490,439, filed on Jul. 28, 2003, entitled System and Method for Controlling a Storage Device, which application is hereby incorporated herein by reference.

### TECHNICAL FIELD

The present invention relates to computing device control of a storage device, and more particularly control using read and write operations.

### BACKGROUND

Computer storage is the holding of data in an electromagnetic form for access by a computer processor. The storage may be divided to primary storage, such as random access memory (RAM), and secondary storage such as hard disks, also referred to as bulk storage. Secondary storage may be further divided into internal storage, such as, in one example, a hard drive that is shipped with a PC, and external storage, such as a removable hard drive that connects to the PC through the Universal Serial Bus (USB) interface. The PC, also called host PC, or another host device with a computer processor, controls a particular storage device by a software program called a device driver. A device driver essentially converts the more general input/output instructions of the operating system to messages that the device can understand.

A common standard for implementing bulk storage devices is a “block device” model. Block devices manage their storage in fixed sized blocks, for example blocks of 512 bytes. Each block is assigned a Logical Block Address (LBA), which can be addressed by the device driver. A software layer known as a file system, which is a part of the operating system that resides on the host PC or host device, performs the operation of managing files using storage blocks.

In order to manage files on a block device, a file system uses READ BLOCK and WRITE BLOCK commands, which essentially enable retrieving blocks of data from the storage device and writing blocks of data to the storage device. Usually one of the parameters of these commands is the LBA of the particular block of interest. The file system maintains structured management data in one or more storage blocks which assists in performing file based operations, such as creating a file, retrieving data from a file, etc. An example of such a structure is the FAT (File Allocation Table) file system. The FAT table keeps track of which LBA's were used and for what purpose. For example, a FAT table may contain the ordered series of LBA's used to store a certain file. Since during the operation of a storage device, this data may go through many changes, some operating systems cache the data to the RAM in order to gain speed, and then write the changed data back to the storage at appropriate occasions.

Other commands sent to block devices are CONTROL commands, enabling the host computer to perform control operations on the storage device based on the parameters of the command. Examples are formatting the storage device, initiating a self-test diagnostic operation, changing internal device parameters, and vendor specific commands.

Since CONTROL operations, if used improperly, might be harmful to the integrity of the storage device, popular operating systems such as the Windows and Mac OS families place certain restrictions on the usage of CONTROL commands. For example the CONTROL command in Windows “DeviceIoControl( )” is restricted to users that have administrative permissions only. The underlying logic of this approach is that, for normal uses, the READ and WRITE commands suffice, whereas CONTROL commands are needed only in setup and configuration scenarios. In corporations and enterprises where an IT administrative team handles configuration of many PCs, this reduces the risk of inexpert computer users causing damage to the storage device or a loss of data by trying to do configuration and setup operations themselves.

In the past few years a new type of storage device has emerged, collectively known as USB flash drive or keychain storage. This is an external storage device based on non-volatile flash technology and connected to the host PC or host device using the USB interface. Examples are Sony MicroVault, Dell Memory Key, and M-Systems DiskOnKey (www.diskonkey.com). These storage devices usually have some computational power and therefore may perform other tasks other than just serving as a storage device. Examples are MicroVault AutoLogin which automatically fills website user IDs and passwords, and Password Lock, enabling password protection of any portion of the storage device's contents. Another example is DiskOnkey MyKey—a graphic user interface that lets users designate frequently used files for quick and easy transfer, choose language preferences, and set audio or visual indications for new data. Still another example is the ability to upgrade the software that is to run on the storage device, as shown by Cyberkey's “future-proof technology” (www.cyberkeycorp.com). Other and more complex applications are feasible.

The common feature of the above-mentioned applications and others is that they are executed both on the host PC and on the storage device itself using its own controller. In order to function properly, the program running on the host PC and the program running on the storage device must interact by transferring information between each other.

Since these storage devices operate under the block device model, the common method to create a communications channel is by using a CONTROL command. However, this interface is available only to host devices configured as administrative users, which means that in order to run the aforementioned storage device applications, users must be granted administrative permissions. While technologically feasible, many organizations will not enable administrative permissions to all employees or other users due to the risk of damage users might cause to other components of their computers.

There is clearly an unmet need for enabling users to run applications on the storage device while permissions in the host device are set at a non-administrative level.

### SUMMARY OF THE INVENTION

The above-mentioned problem is addressed by the various embodiments of the present invention, which will be understood by reading the following specification.

According to the present invention, the means to communicate between a PC Application executing in the host computer and the Storage Application executing inside a storage device is achieved through the use of one or more files in the storage device, to which both applications have access.

The PC Application accesses the file or files using the WRITE BLOCK and READ BLOCK commands and access to the file or files does not necessitate administrative permissions. The content written to such a file includes commands, data and parameters addressed to the Storage Application to execute or process. In a similar manner, when the host issues a READ command to the file, the storage device returns a response from the Storage Application by reading from such a file.

The foregoing has outlined rather broadly the features and technical advantages of embodiments of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims, and such equivalent structures fall within the scope of the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic block diagram of a system including a Client Channel Application Layer and a Server Channel Application Layer;

FIG. 2 is a flow chart of a preferred exemplary method of the invention depicting the steps of initiating the communication channel;

FIG. 3 is a flow chart of a preferred exemplary method of the invention depicting the steps of sending a message from a software application executing in the host computer or device to the storage application executing in the storage device using READ BLOCK and WRITE BLOCK commands; and

FIG. 4 is a flow chart of a preferred exemplary method of the invention depicting the steps of sending a message from the storage application executing in the storage device to a software application executing in the host computer or device using READ BLOCK and WRITE BLOCK commands.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The structure, making and using of the presently preferred embodiments of the invention are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention or the appended claims

In the following description of exemplary embodiments of the invention, reference is made to the drawings that illustrate specific exemplary embodiments in which the invention may be practiced. Those skilled in the art will appreciate that other embodiments may be utilized without departing from the spirit of the present invention; therefore the following detailed description of the invention should not be taken in a limiting sense. In various embodiments, there may be none, one, or more than one of the following described parts.

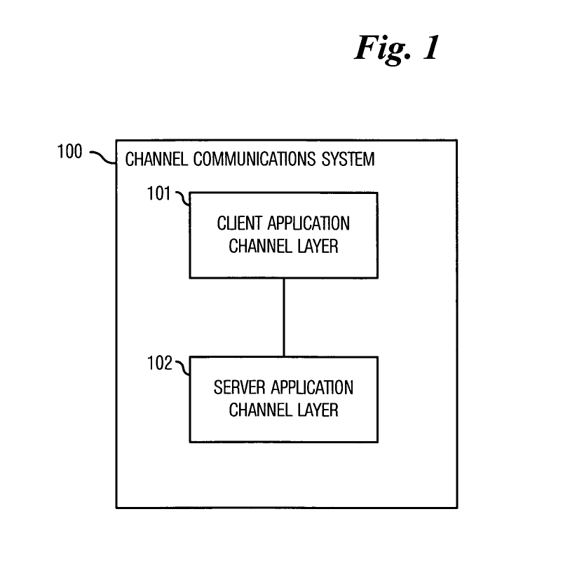

FIG. 1 illustrates an exemplary embodiment of the system 100, including a Client Application Channel Layer 101 and a Server Application Channel Layer 102.

The Client Application Channel Layer 101 is software executing in the host PC or device and used by a PC Application to send and retrieve commands, data and parameters to and from the Storage Application. The Client Application Channel Layer 101 performs operations such as: accepting requests from the PC Application, converting the requests into a sequence of one or more READ BLOCK and/or one or more WRITE BLOCK commands, sending responses to the PC Application, housekeeping, and management of the communication process and the like.

The Server Application Channel Layer 102 is software executing in the storage device and used to identify READ BLOCK and/or WRITE BLOCK commands addressed to a certain file or plurality of files. When such a command is identified, the Server Application Channel Layer 102 processes the request by performing one or more operations such as forwarding the command to the Storage Application, retrieving or storing some data, returning some values to the Client Application Channel Layer 101 or the like operations. In some embodiments, the Client Application Channel Layer 101 or parts of the Client Application Channel Layer 101 are integrated into the PC Application, this invention is not so limited.

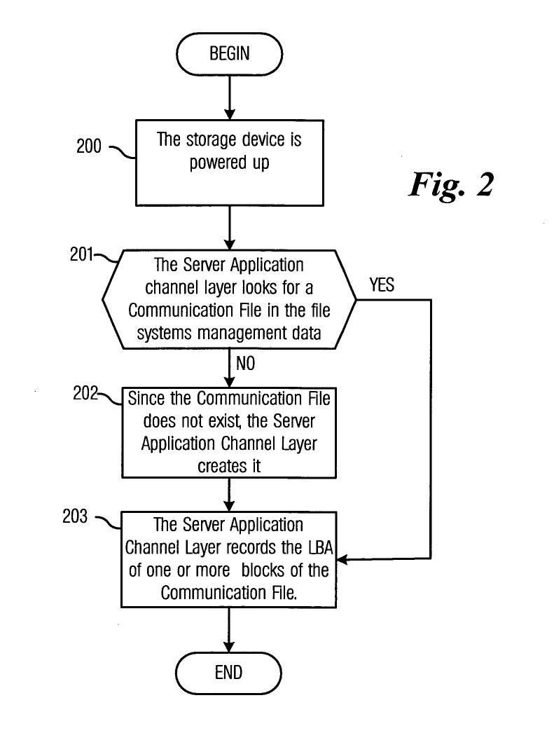

FIG. 2 is a flow chart describing an exemplary sequence of operations carried out to initiate the communication channel in an exemplary embodiment of the invention. In step 200 the storage device is powered up, however, if the storage device has already been powered up no change in status in the storage device occurs in this step, and the sequence progresses to step 201. In step 201 the Server Application Channel Layer searches the file system's management data system that resides in the storage media of the storage device for a specific file, hereafter referred to as a Communication File. In some embodiments this structure can be the FAT structure in case of a FAT file system, in other embodiments it can be a different file system such as NTFS or others, the invention is not so limited.

In step 202, in those cases that the Communication File could not be located, the Server Application Channel Layer creates it. In some embodiments this may be implemented by creating and placing a new file in the root directory or in a sub-directory of a FAT file system. In some embodiments, the creation process will also allocate one or more storage blocks for the Communication File. In some embodiments, the creation process will also fill some storage blocks with data. In step 203, the Server Application Channel Layer records one or more LBA's that were allocated for the Communication File.

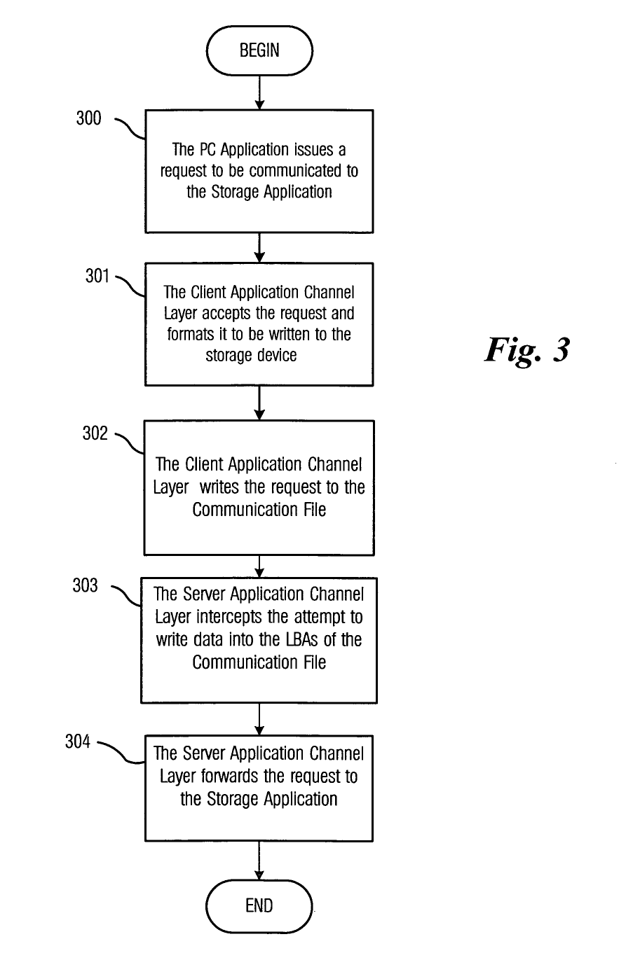

FIG. 3 is a flow chart describing an exemplary sequence of operations carried out in a preferred embodiment when a message from the PC Application is sent to the Storage Application. In step 300 the PC Application issues a request to be processed by the Storage Application. In step 301 the Client Application Channel Layer accepts the request and optionally performs some processing such as formatting the request and/or setting some parameters and/or initiating a different working mode or the like.

In step 302, the Client Application Channel Layer sends the request to the storage device by writing into the Communication File. This operation engages the file system and the operating system running in the host PC to generate a series of none, one or more WRITE_BLOCK commands and/or none, one or more READ_BLOCK commands eventually requesting the storage device to place the sent data in LBA's that are allocated for the Communication File. In some embodiments, the Client Application Channel Layer opens a file for each request and closes it once the request is completed. In other embodiments the Client Application Channel Layer opens the file once at the beginning of the session and closes it upon completion. Yet in other embodiments, a combination of the above is implemented, the invention is not so limited.

In step 303 the Server Application Channel Layer intercepts the attempt to write data blocks into the LBA's of the Communication File or read blocks from them. In step 304 the Server Application Channel Layer optionally processes or partially processes the request and forwards it to the Storage Application.

In some embodiments the Communication File is limited in size beyond its initial size while in other embodiments it is allowed. In some embodiments, if the file is expanded, the blocks beyond the initial size are not recorded by the Server Application Channel Layer in order to enable their capturing, while in other embodiments they are recorded. In some embodiments the Communication File allocated storage blocks may be modified as result of the WRITE BLOCK operation and in other embodiments they are not modified. It may be appreciated by those skilled in the art that other embodiments, or combinations of such embodiments may exist without departing from the spirit of the present invention.

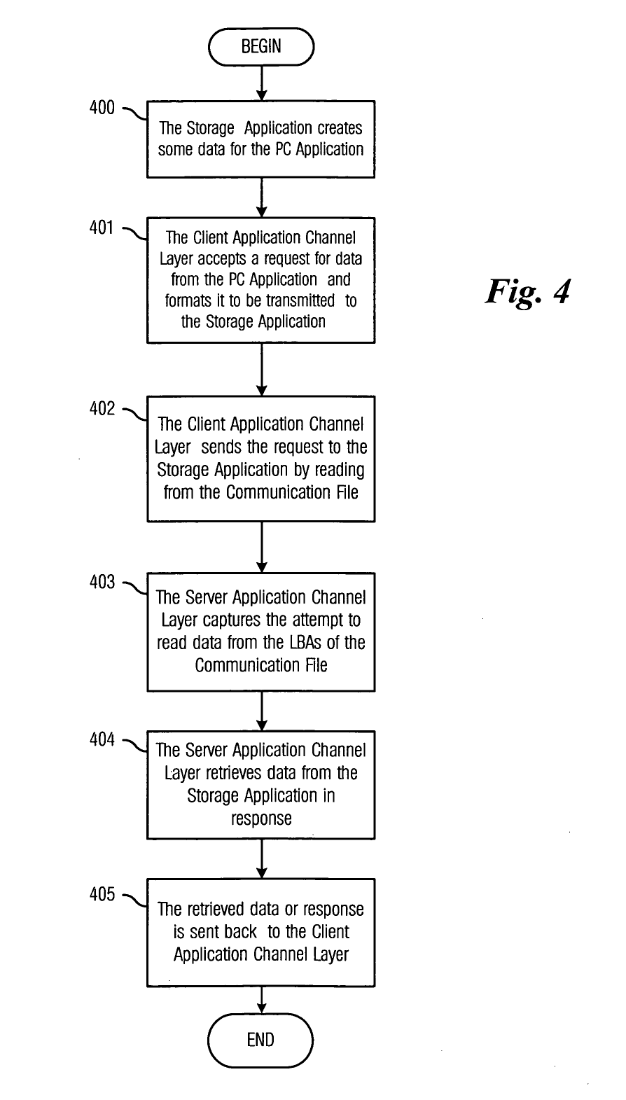

FIG. 4 is a flow chart describing an exemplary sequence of operations carried out in a preferred embodiment when a response from the Storage Application is sent to the PC Application. In step 400 Storage Application creates some data and/or response for the PC Application. In step 401 the Client Application Channel Layer accepts a request to read some data and/or a response from the PC Application.

In step 402 the Client Application Channel Layer sends the request to the storage device by reading from the Communication File. This operation engages the file system and the operating system running in the host PC to generate a series of none, one or more READ_BLOCK commands eventually requesting the storage device to retrieve the data that is stored in LBA's that are allocated for the Communication File. In some embodiments the Client Application Channel Layer opens a file for each request and closes it once the request is completed. In other embodiments the Client Application Channel Layer opens the file once at the beginning of the session and closes it upon completion. Yet in other embodiments a combination of the above is implemented, the invention is not so limited.

In step 403, the Server Application Channel Layer captures the attempt to read data blocks from the LBA's of the Communication File. In step 404 the Server Application Channel Layer optionally processes or partially processes the read request and forwards it to the Storage Application to retrieve data or a response. In step 405 the retrieved data and/or response is sent back to the Client Application Channel Layer to complete the Communication File read operation.

In some embodiments, parts of the Client Application Channel Layer are integrated with the PC Application, enabling operations such as initializing, and/or writing to the Communication and/or reading from the Communications File or the like to be implemented in the integrated PC Application.

In other embodiments, a plurality of Communication Files is used for various purposes; for example one file may be used by the Client Application Channel Layer to execute write operations while a second file might be used to execute read operations.

In yet other embodiments, the storage device may enable more than one Storage Application, and the Communication File is used to enable access to all. In another embodiment a plurality of Communication Files are used, one or more for each of the Storage Applications.

In still further embodiments, the data being written by the Client Application Channel Layer is actually written into the LBA's of the file and the Server Application Channel Layer is triggered to read the LBA's.

In still further embodiments, the data being read by the Client Application Channel Layer is actually read from the LBA's of the communication file by Server Application Channel Layer Server. The invention is not so limited.

Although embodiments of the present invention and their advantages have been described in detail, it should be understood that various changes, substitutions and alterations can be made herein without departing from the spirit and scope of the invention as defined by the appended claims. For example, it will be readily understood by those skilled in the art that many of the features, functions, processes, and materials described herein may be varied while remaining within the scope of the present invention. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. An apparatus for communicating with a host device, comprising:
an interface for transmitting and receiving data to a host device;
a storage controller associated with the interface;
storage media associated with said storage controller;
the storage controller being configured to:
detect an access attempt by the host device to a designated region in the storage media, the access attempt having a control portion and a data portion;
extract at least a datum from within said data portion;
interpret said extracted at least a datum as at least a control message for the storage controller; and
execute at least an operation in the storage controller responsive to the at least a control message from the host device.

2. The apparatus of claim 1 wherein the storage controller is further configured to:
receive data associated with said at least a control message from the host device; and
responsive to said at least a control message, at least store data in certain locations in the storage media.

3. The apparatus of claim 1 wherein the storage controller is further configured to:
receive a read access attempt for data to said designated region in the storage media following the execution of the at least an operation associated with said at least a control message from the host device; and
responsive to the read access attempt execute at least an operation in the storage device.

4. The apparatus of claim 3, wherein the at least an operation executed in the storage device at least retrieves one datum from the storage media for transmission to the host device.

5. The apparatus of claim 3, wherein the storage device interfaces with the host device which is not operating under administrative permissions.

6. The apparatus of claim 1 wherein said interface, storage controller and storage media together comprise a removable flash storage device.

7. The apparatus of claim 1 wherein said interface is operable with the USB standard.

8. A computer program product associated with a removable storage device having an interface for communication to a host device, comprising:
storage application computer program code for executing a storage application on a controller on a removable storage device, the storage application program code being responsive to at least a command to the storage device by an access attempt from the host device to a designated region in the storage media of the storage device, the access attempt having a control portion and a data portion, the at least a command being within the data portion.

9. The computer program product of claim 8, further comprising:
application computer program code for executing an application program on a host device, which, when executing the application program, will attempt access to files recognized to be located on the storage device.

10. The computer program product of claim 9, further comprising:
computer program code for executing a client channel application layer on the host device for receiving messages from the application program and for transmitting messages to the storage device.

11. The computer program product of claim 9, further comprising:
computer program code for executing a server channel application layer on the storage device for receiving messages from the storage application program and for transmitting messages to the host device.

12. The computer program product of claim 10, further comprising:
computer program code for executing a server channel application layer on the storage device for receiving messages from the storage application program and for transmitting messages to the host device.

13. The computer program product of claim 12, wherein
the host device and the storage device communicate by transmitting and receiving data from the client channel application layer and the server channel application layer.

14. The computer program product of claim 9 wherein the application program executing on the host device does not have administrative permissions.

15. The computer program product of claim 9, wherein
said application program is executable on a host device which is a computer having a USB port and said interface for communication to the host device is operable with the USB standard.

16. A method for communicating between a host device and a storage device, comprising the steps of:
providing an interface for transmitting and receiving data between the host device and the storage device;
providing a storage device, comprising:
a storage controller associated with the interface; and
storage media associated with said storage controller;
detecting an access attempt by the file system of the host device to a designated region in the storage media, the access attempt having a control portion and a data portion;
extracting at least a datum from within said data portion;
interpreting said extracted datum as at least a control message for the storage controller; and
executing at least an operation in the storage controller responsive to the at least a control message from the host device.

17. The method of claim 16, further comprising the steps of:
receiving data associated with said at least a control message from the host device; and
responsive to said at least a control message, at least storing data in certain locations in the storage media.

18. The method of claim 16, further comprising the steps of:
receiving a read access attempt for data to said designated region in the storage media following the execution of the at least an operation associated with said at least a control message from the host device; and
responsive to the read access attempt executing at least an operation in the storage device.

19. The method of claim 18 wherein the step of executing at least an operation further comprises the steps of:
at least retrieving one datum from the storage media for transmission to the host device.

20. A method for communicating between a host device and a storage device, comprising the steps of:
utilizing at least one or more Logical Block Addresses in the storage device for an access attempt by the host device as at least a communications file and for access by the storage device;
detecting an access attempt by the file system of the host device to the at least a communications file, the access attempt having a control portion and a data portion;
extracting at least a datum from within said data portion;
interpreting said at least a datum as a at least a control message from the host device to the storage device; and
executing at least an operation in the storage device responsive to the at least a control message from the host device.

21. The method of claim 20, further comprising the steps of:
receiving data associated with said at least a control message from the host device; and
responsive to said at least a control message, at least storing data in certain locations in the storage device.

22. The method of claim 20, further comprising the steps of:
receiving a read access attempt to the communications file for data associated with the control message from the host device; and
responsive to the read access attempt associated with the control message, executing at least an operation in the storage device.

23. The method of claim 22 wherein the step of executing at least an operation in the storage device further comprises the steps of at least retrieving one datum for transmission from the storage device to the host device.

24. An apparatus for communicating with a host device, comprising:
an interface for transmitting and receiving data to a host device;
a storage controller associated with the interface;
storage media associated with said storage controller;
the storage controller being configured to:
utilize at least one or more Logical Block Addresses in the storage device for access by the host computer as at least a communications file and for access by the storage device;
detect an access attempt by the file system of the host device to the at least a communications file, the access attempt having a control portion and a data portion;
extract at least a datum from within said data portion;
interpret said extracted at least a datum as at least a control message for the storage controller; and
execute at least an operation in the storage controller responsive to the at least a control message from the host device.

25. The apparatus of claim 24 wherein the storage controller is further configured to:
receive data associated with said at least a control message from the host device; and
responsive to the at least a control message, at least store data in certain locations in the storage media.

26. The apparatus of claim 24, wherein the storage controller is further configured to:
detect a read access attempt for data to the communication file following the execution of the at least an operation associated with the at least a control message from the host device; and
responsive to the read access attempt execute at least an operation in the storage device.

27. The apparatus of claim 24, wherein the operation executed in the storage device retrieves at least one datum from the storage media for transmission to the host device.

28. The apparatus of claim 24, wherein the host device does not have administrative permissions.

29. The apparatus of claim 24 wherein said interface, storage controller and storage media together comprise a removable flash storage device.

30. The apparatus of claim 24 wherein said interface is operable with the USB standard.

31. A system, comprising:
a host device executing an application program;
a storage device in communication with the host device executing a storage application program;
a communication file recognized to be located on the storage device and accessible to the file system of the host device;
wherein the storage device detects an access attempt to the communications file by the file system including a control portion and a data portion and interprets at least a datum from the data portion of the access attempt as a control message from the host device and the storage device extracts said at least a datum from the data portion and executes at least an operation responsive to the control message from the host device.

32. The system of claim 31 wherein the application program executing on the host device does not have administrative permissions.

33. The system of claim 31 wherein the storage device is in communication with the host device over a communications interface that is operable with the USB standard.

34. The system of claim 31 and further comprising:
a storage controller on the storage device; and
storage media on the storage device, operable to store and retrieve data responsive to said storage controller.

35. The system of claim 31 and further comprising:
a client channel application layer executing on the host device and in communication with the application program and the file system; and
a server channel application layer executing on the storage device and in communication with the storage application program , wherein the server channel application layer performs the at least the step of detecting an access attempt to the communication file by the file system;
the host device and the storage device communicating by transmitting and receiving data from the client channel application layer and the server channel application layer.

36. A method for communication between a host device and a storage device, comprising the steps of:
providing a communications interface for communicating to the storage device;
executing a host application program on the host device, the host device application program executing without administrative privileges;
executing a storage application program on the storage device;
executing a client channel application layer on the host device for receiving messages from the host application program and transmitting the messages to the storage device;
executing a server channel application layer on the storage device for receiving messages from the host device and for transmitting messages to the storage application program;
detecting an access attempt to a designated region in the storage device in the server application channel layer, the access attempt having a control portion and a data portion;
extracting at least one datum from the data portion of the access attempt;
interpreting at least one datum as at least a control message to the storage application program;
transmitting the at least a control message to the storage application program from the server application channel layer; and
executing at least an operation in the storage application program responsive to the at least a control message.

37. An apparatus, comprising:
interface means for transmitting and receiving data;
storage control means associated with said interface means;
storage media means for storing and retrieving data responsive to said interface means;
said storage control means being configured to:
detect an access attempt to a designated region of said storage media means, the access attempt comprising a control portion and a data portion;
extract at least a datum from within said data portion;
interpret said at a least a datum as at least a control message from a host device; and
execute at least an operation responsive to the at least a control message from the host device.

38. The apparatus of claim 37, wherein said interface means comprises means operable with the USB standard.

39. The apparatus of claim 37, wherein said storage media means comprises non-volatile storage means.

40. The apparatus of claim 37, wherein said host device is a personal computer.

41. The apparatus of claim 37, wherein said storage control means is further configured to:
utilize at least one or more Logical Block Addresses in the storage media means for access by the host device as at least a communications file and for access by the storage control means.
